(19) United States
(12) Patent Application Publication
(10) Pub. No.: US 2009/0208270 A1
(43) Pub. Date: Aug. 20, 2009

(54) OPTICAL READER MARKER

(76) Inventors: Andrea K. Gregerson, Omaha, NE (US); Leslie S. Allbery, Omaha, NE (US); Lori L. Stangl, Omaha, NE (US); Jennifer A. Smith, Omaha, NE (US)

Correspondence Address: ADVANTIA LAW GROUP, 9035 SOUTH 1300 EAST, SUITE 200, SANDY, UT, 84094, US

(21) Appl. No.: 12/368,101

(22) Filed: Feb. 9, 2009

Related U.S. Application Data
(60) Provisional application No. 61/028,651, filed on Feb. 14, 2008.

(51) Int. Cl. B43K 31/00

(52) U.S. Cl. 401/138

(57) ABSTRACT

There is a marker configured to dispense a fluid. The marker includes a fluid container configured to store a fluid. The marker also includes a dispenser configured to selectably dispense a fluid. The marker further includes a tip head coupled to the dispenser, wherein the tip head includes a substantially rigid frontal profile configured to apply the fluid from the dispenser to a surface in a two-dimensional shape substantially identical to the frontal profile. The tip head is selectably removable; wherein the tip head includes a plurality of tip heads each having substantially different frontal profiles. The tip head further includes a daubing protrusion. The marker includes a fluid disposed within the fluid container, wherein the fluid is a machine readable ink. The marker also includes an eraser coupled to the fluid container, opposite of the dispenser, respectively, and configured to erase the fluid deposited on a paper substrate.

### CROSS-REFERENCE TO RELATED APPLICATIONS

This invention claims priority, under 35 U.S.C. §120, to the U.S. Provisional Patent Application No. 61/028,651 to Andrea Gregerson filed on Feb. 14, 2008, which is incorporated by reference herein.

### BACKGROUND OF THE INVENTION

1. Field of the Invention

The present invention relates to writing utensils, specifically to an optical reader marker suitable for marking documents intended for processing optical readers.

2. Description of the Related Art

It is time consuming and sometimes difficult to properly fill in answer bubbles in documents intended for optical readers. Especially, during a timed examination for a license, profession, or just for school. In addition, if the answer bubble is not completely and properly filled in or is filled into another answer bubble, the optical reader might have a problem reading and accurately scoring the document. Some improvements have been made in the field. Examples of references related to the present invention are described below, and the supported teachings of each reference are incorporated by reference herein:

U.S. Pat. No. 5,169,439, issued to Horvat et al., discloses a marking fluid based on an aqueous solution of hydroxyprene trisulfonic acid as a fluorescence dyestuff and having a pH-value in the alkaline range. The marking fluid further includes at least one mono, oligo or polysaccharide, or a polyol derived therefrom by reduction, or a mixture thereof, to improve the properties of the fluid in a number of respects. The marking fluid can be used on a wide range of different surfaces and affords improved fastness in relation to light.

U.S. Pat. No. 4,826,338, issued to Kilpatrick, discloses a multi-tipped pen and a pen/pen holder combination are disclosed. The multi-tipped pen has an even number of pen tips spaced at a set distance to enable to user to draw simultaneously parallel lines. The pen is used by layout artists to indicate the placing and size of printed material that will appear in the final version of an advertisement. The distance between the pen tips indicates the size of type to be used. The pen may be located within a pen holder that prevents the pen tips from drying out.

U.S. Pat. No. 5,336,307, issued to Horvat et al., discloses a marker pencil comprises a gel-like water-bearing pencil material enclosed in a casing and incorporating a dye carrier. The structure-forming constituents of the pencil material include water-soluble metal soaps and saccharides and/or polyols derived therefrom by reduction. As a further alternative constituent the pencil material may include a fatty substance.

U.S. Pat. No. 4,692,046, issued to Lan, discloses a pen containing multi-color cores located in different tubes housed in the pen body, which colors can be optionally selected for use readily using a specially-designed turnable knob having a projected edge in cam contact with the top end of the core-receiving tubes. The top end of the core-receiving tube is pushed downward for use, when the turnable knob is rotated, so to enable a person to select a color core as he wishes quickly and readily.

U.S. Pat. No. 5,017,034, issued to Stary et al., discloses a writing instrument comprises a combined marking pen and a fine line pen, especially useful for providing a highlighter and an underliner or a note writer. It comprises a single elongated body (23) with a felt marking pen tip (25A) and a ballpoint pen tip (27A), both projecting from the bottom end of the body. The ends of the tips are spaced apart in the longitudinal direction of the body and in a second direction perpendicular to the longitudinal direction. This enables a user to write with either tip by holding the pen at either of two angles to the vertical. The spacing in the second direction can be effected, even if the felt body and the ballpoint cartridge are adjoining, by providing a cutout (24) in the felt tip adjacent the ball point tip. The pen can include two ballpoint tips (57A, 57B), spaced from the marker's tip in the second direction, but aligned in the longitudinal direction. The body can include a dividing partition (64) to separate the ballpoint cartridge from the felt pen's reservoir.

The inventions heretofore known suffer from a number of disadvantages which include being difficult to use, being cumbersome to use, being bulky, being inefficient, being limited in application, being limited in versatility, and being expensive.

What is needed is an optical reader marker that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available optical reader marker. Accordingly, the present invention has been developed to provide an optical reader marker that accurately and conveniently marks answer bubbles of a score sheet.

In one embodiment of the invention, there is a marker configured to dispense a fluid. The marker may include a fluid container, wherein the fluid container is configured to store a fluid. The fluid container may include an aperture disposed on an end of the fluid container. The fluid container may also include a refill port; wherein the refill port is configured to enable a user to selectably refill the fluid container with a fluid. The fluid container may further include a transparent window, configured to display the fluid disposed within the fluid container. The fluid container may also include a textile matrix configured to suspend the fluid in a liquid state and permit the fluid to pass therethrough.

In addition, the marker may include a dispenser coupled to the end of the fluid container, configured to selectably dispense a fluid. The marker may also include a tip head coupled to the dispenser, wherein the tip head includes a substantially rigid frontal profile configured to apply the fluid from the dispenser to a surface in a two-dimensional shape substantially identical to the frontal profile. The dispenser also includes a threaded attachment member, configured to selectably couple to the tip head. The marker may further include a securing ring, configured to secure the textile matrix within the dispenser and the tip head. The tip head may be selectably removable. The tip head may further includes a plurality of tip heads each having substantially different frontal profiles. The tip head may further include a daubing protrusion.

Furthermore, the marker may include a fluid disposed within the fluid container, wherein the fluid is a machine readable ink. The marker may also include an eraser coupled to the fluid container, opposite of the dispenser, respectively, and configured to erase the fluid deposited on a paper substrate.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a perspective view of a prior art writing utensil, according to one embodiment;

FIG. 2 is a perspective view of an optical reader marker, according to one embodiment of the invention; and

FIG. 3 is a cross sectional view of an optical reader marker, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will, nevertheless, be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

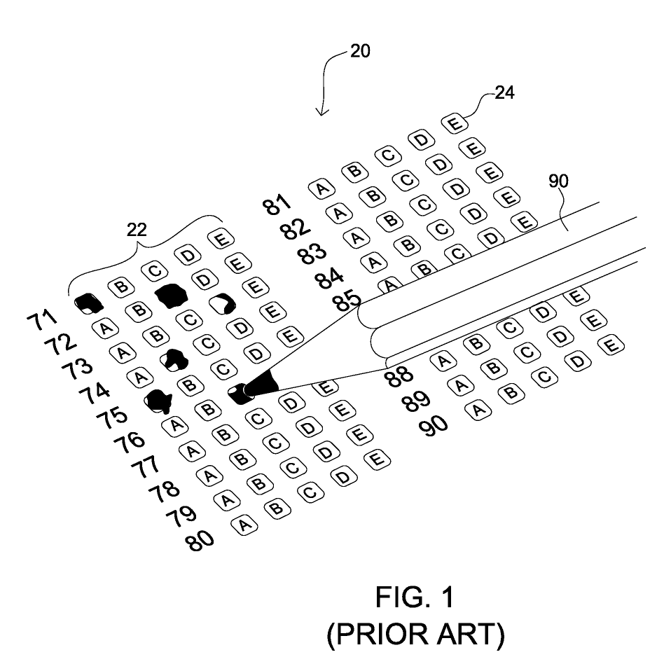

FIG. 1 illustrates a perspective view of a prior art writing utensil, according to one embodiment; wherein the prior art writing utensil is a pencil 90. The pencil 90 is filling in a score sheet 20 having a plurality of bubble fill answer spots 22 having a profile 24. The score sheet 20 is configured to be machine readable; wherein a score sheet readable machine includes an answer-read module configured to detect fluid residue disposed on the score sheet 20.

In operation of the prior art writing utensil, a user uses a pencil to fill in a score sheet. The score sheet correlates to a document; wherein the user must answer questions from the document and record the user's answers on the score sheet. The user fills in answer spots on the score sheet corresponding to the question answered from the document. The answer spots must be filled in with machine readable ink, so the score sheet readable machine may read the answer filled in on the score sheet. Thereby, determining the score of the user from the answer spots filled on the score sheet.

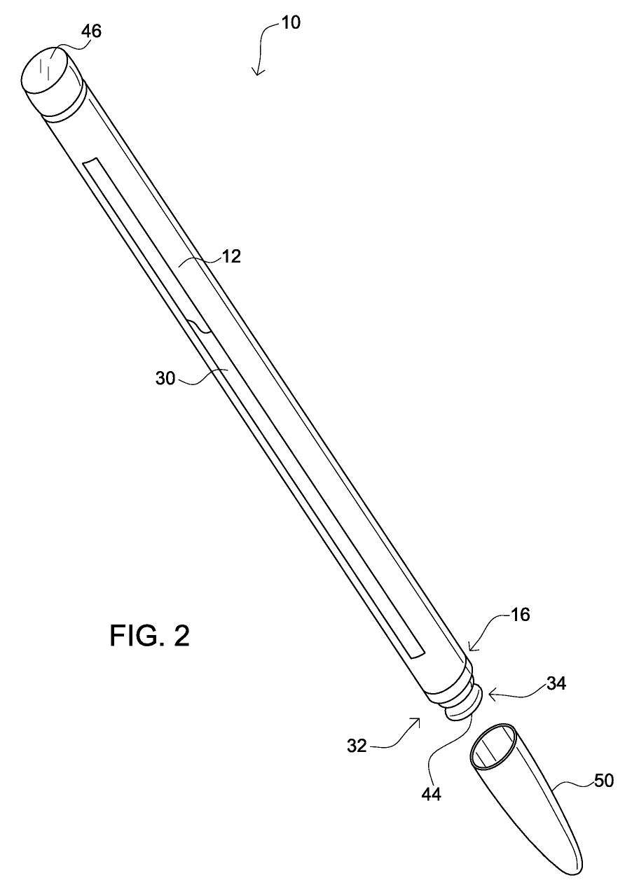

FIG. 2 illustrates a perspective view of a marker 10, according to one embodiment of the invention, wherein the marker 10 is configured to dispense a fluid. The marker 10 includes a fluid container 12, wherein the fluid container 12 is configured to store a fluid. The fluid container 12 includes an aperture 14 disposed on an end 16 of the fluid container 12. The fluid container 12 also includes a transparent window 30, configured to display a fluid disposed within the fluid container 12.

In addition, the marker 10 may also include a dispenser 32 coupled to the end 16 of the fluid container 12, configured to selectably dispense a fluid. The marker 10 also includes a tip head 34 coupled to the dispenser 32, wherein the tip head 34 includes a substantially rigid frontal profile configured to apply the fluid from the dispenser 32 to a surface in a two-dimensional shape substantially identical to the frontal profile. The tip head 34 further includes a plurality of tip heads each having substantially different frontal profiles. The tip head 34 also includes a daubing protrusion 44. Furthermore, the marker 10 includes a cap 50, wherein the cap 50 is configured to seal the marker 10. The marker 10 includes a fluid disposed within the fluid container 12, wherein the fluid is a machine readable ink. The marker 10 further includes an eraser 46 coupled to the fluid container 12, opposite of the dispenser 32, respectively, and configured to erase the fluid deposited on a paper substrate.

In operation of one embodiment of the invention, a user begins taking an examination and removes the cap from the marker. The user fills in the score sheet of the examination with the daubing protrusion of the marker. The user presses above the answer spot on the score sheet corresponding to the question from the examination. The answer spots must be filled in with machine readable ink, so the score sheet readable machine may read the answered filled in on the score sheet. Thereby, determining the score of the user from the answer spots filled on the score sheet. The user may use the eraser to remove any unwanted marks left by the daubing protrusion of the marker. The user may dispose the cap over the daubing protrusion and seal the marker.

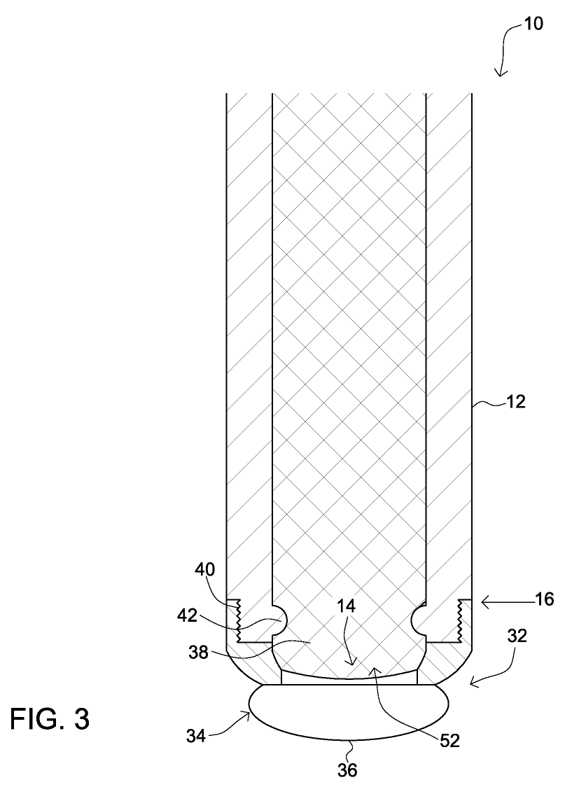

FIG. 3 is a cross sectional view of a marker 10, according to one embodiment of the invention, wherein the marker 10 is configured to dispense a fluid. The marker 10 includes a fluid container 12, wherein the fluid container 12 is configured to store a fluid. The fluid container 12 includes an aperture 14 disposed on an end 16 of the fluid container 12. The fluid container 12 also includes a refill port 52; wherein the refill port 52 is configured to enable a user to selectable refill the fluid container 12 with a fluid. The fluid container 12 also includes a textile matrix 38 configured to permit the fluid to pass therethrough.

In addition, the marker 10 includes a dispenser 32 coupled to the end 16 of the fluid container 12, configured to selectably dispense a fluid. The marker 10 also includes a tip head 34 coupled to the dispenser 32, wherein the tip head 34 includes a substantially rigid frontal profile 36 configured to apply the fluid from the dispenser 32 to a surface in a two-dimensional shape substantially identical to the frontal profile 36. The dispenser 32 also includes a threaded attachment member 40, configured to selectably couple to the tip head 34. The marker 10 further includes a securing ring 42, configured to secure the textile matrix 38 within the dispenser 32 and the tip head 34. The tip head 34 is selectably removable. The tip head 34 further includes a plurality of tip heads each having substantially different frontal profiles. The tip head 34 also includes a daubing protrusion 44.

Furthermore, the marker 10 includes a fluid disposed within the fluid container 12, wherein the fluid is a machine readable ink. The marker 10 also includes an eraser 46 coupled to the fluid container 12, opposite of the dispenser, respectively, and configured to erase the fluid deposited on a paper substrate.

In operation of one embodiment of the invention, a user begins taking an examination and fills in the score sheet of the examination with the daubing protrusion of the marker. The user presses above the answer spot on the score sheet corresponding to the question from the examination. The answer spots must be filled in with machine readable ink, so the score sheet readable machine may read the answers filled in on the score sheet. Thereby, determining the score of the user from the answer spots filled on the score sheet. The user may remove the daubing protrusion and expose the refill port. The user disposes a fluid through the textile matrix and refills the fluid marker with a fluid. The user may dispose the daubing protrusion over the textile matrix, thereby enabling use. In addition, the user may remove the daubing protrusion and insert another tip head configured with a different frontal profile depending upon the type of answer spot on the score sheet.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a score sheet including an answer spot substantially square in configuration, one skilled in the art would appreciate that the tip heads may be configured to any type of answer spot design. Examples are, but not limited to: substantially circular, substantially oval, substantially rectangular, substantially square, substantially triangular, substantially polygonal, etc. and still perform its intended function.

It is envisioned that one skilled in the art would appreciate that the score sheet may be, but not limited to: a voting ballot, a lottery ticket, a survey, a petition, or any other document that may be read with an optical reader. It is further envisioned that the score sheet may be read manually without the use of the score sheet readable machine.

Additionally, although the figures illustrate specific embodiments, it is envisioned, one skilled in the art would appreciate, that further embodiments may include combinations not heretofore illustrated of the illustrated features and structures and still perform its intended function.

It is also envisioned, one skilled in the art would appreciate, that the marker may include a retract mechanism, wherein the retract mechanism is disposed in between the fluid container and the eraser. The retract mechanism is configured to retract the tip head of the dispenser, thereby relieving the need for a cap to cover the tip head when not in use. The retract mechanism includes a bias member, a washer member, and an activation member.

In addition, it is envisioned that one skilled in the art would appreciate that the eraser may be disposed on the cap of the marker and still perform its intended function. Furthermore, one skilled in the art would appreciate that the textile material may be, but not limited to a sponge, a fiber matrix, and a textile matrix.

Finally, it is envisioned, one skilled in the art would appreciate, that the components of the device may be constructed of a variety of materials, including but not limited to plastic, rubber, textile, metal, ceramic, fiber, wood, and combinations thereof, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to, consist of, or to consist essentially of, one or more of the features, functions, structures, or methods described herein.

What is claimed is:

1. A marker configured to dispense a fluid, comprising:
a) a fluid container, configured to store a fluid; wherein the fluid container includes an aperture disposed on an end of the fluid container;
b) a dispenser coupled to the end of the fluid container, configured to selectably dispense a fluid;
c) a tip head coupled to the dispenser, the tip head having a substantially rigid frontal profile configured to apply the fluid from the dispenser to a surface in a two-dimensional shape substantially identical to the frontal profile; and
d) a fluid disposed within the fluid container, wherein the fluid is a machine readable ink.

2. The marker of claim 1, wherein the fluid container includes a refill port.

3. The marker of claim 1, wherein the fluid container further includes a textile matrix configured to permit the fluid to pass therethrough.

4. The marker of claim 1, wherein the marker further includes an eraser coupled to the fluid container, opposite of the dispenser, respectively, and configured to erase the fluid deposited on a paper substrate.

5. The marker of claim 1, wherein the dispenser further includes a threaded attachment member, configured to selectably couple to the tip head.

6. The marker of claim 1, wherein the tip head further includes a daubing protrusion.

7. The marker of claim 1, wherein the marker further includes a securing ring, configured to secure the textile matrix within the fluid container.

8. The marker of claim 1, wherein the fluid container further includes a transparent window, configured to display the fluid disposed within the fluid container.

9. The marker of claim 1, wherein the tip head is selectably removable.

10. The marker of claim 1, wherein the tip head further includes a plurality of tip heads each having substantially different frontal profiles.

11. A test-taking kit for facilitating evaluating a user, comprising:
a daubing pen, including:
a fluid container, configured to store a fluid; wherein the fluid container includes an aperture disposed on an end of the fluid container;
a dispenser coupled to the end of the fluid container, configured to selectably dispense a fluid;
a tip head coupled to the dispenser, the tip head having a substantially rigid frontal profile configured to apply fluid from the dispenser to a surface in a two-dimensional shape substantially identical to the frontal profile; and
a fluid disposed within the fluid container, wherein the fluid is a machine readable ink;
a score sheet having a plurality of bubble fill answer spots having a profile matching the frontal profile of the tip head; and
a score sheet reading machine including a answer-read module configured to detect fluid residue disposed on the score sheet.

12. The test-taking kit of claim 11, wherein the fluid container includes a refill port.

13. The test-taking kit of claim 12, wherein the fluid container further includes a textile matrix configured to permit the fluid to pass therethrough.

14. The test-taking kit of claim 13, wherein the test-taking kit further includes an eraser coupled to the fluid container, opposite of the dispenser, respectively, and configured to erase the fluid deposited on a paper substrate.

15. The test-taking kit of claim 14, wherein the dispenser further includes a threaded attachment member, configured to selectably couple to the tip head.

16. The test-taking kit of claim 15, wherein the tip head further includes a daubing protrusion.

17. The test-taking kit of claim 16, wherein the test-taking kit further includes a securing ring, configured to secure the textile matrix within the fluid container.

18. The test-taking kit of claim 17, wherein the fluid container further includes a transparent window, configured to display the fluid disposed within the fluid container.

19. The test-taking kit of claim 18, wherein the tip head is selectably removable.

20. The test-taking kit of claim 19, wherein the tip head further includes a plurality of tip heads, each having substantially different frontal profiles.
